(19) United States
(12) Patent Application Publication
(10) Pub. No.: US 2010/0059917 A1
(43) Pub. Date: Mar. 11, 2010

(54) METHOD OF DELIVERING A PRINTED PRODUCT TO A BINDING OR MAILING LINE

(75) Inventor: William T. Graushar, Elm Grove, WI (US)

Correspondence Address: MICHAEL BEST & FRIEDRICH LLP, 100 E WISCONSIN AVENUE, Suite 3300, MILWAUKEE, WI, 53202, US

(73) Assignee: QUAD/GRAPHICS, INC., Sussex, WI (US)

(21) Appl. No.: 12/621,538

(22) Filed: Nov. 19, 2009

Related U.S. Application Data
(63) Continuation of application No. 11/959,685, filed on Dec. 19, 2007, now abandoned.
Application No. 11/959,685 is a continuation of application No. 10/378,135, filed on Mar. 4, 2003, now abandoned.

(51) Int. Cl. B42B 2/00; B65H 39/00

(52) U.S. Cl. 270/52.14; 270/52.18

(57) ABSTRACT

A method of delivering signatures to a finishing line includes generating an assembly order. The assembly order is provided to a controller that is operatively associated with a feeder that comprises a print-on-demand printer. Paper is provided to the print-on-demand printer. The controller controls printing on a signature with the print-on-demand printer according to the assembly order. The controller controls feeding the signature to a first pocket on the finishing line and delivering the signature from the first pocket to the finishing line according to the assembly order. The controller controls printing on an additional signature with the print-on-demand printer according to the assembly order. The controller controls feeding the additional signature to the first pocket, and delivering the additional signature from the first pocket to the finishing line according to the assembly order.

### CROSS-REFERENCE TO RELATED APPLICATIONS

This application is a continuation of U.S. patent application Ser. No. 11/959,685, filed Dec. 19, 2007, which is a continuation of U.S. patent application Ser. No. 10/378,135, filed Mar. 4, 2003, the entire contents of both applications are hereby incorporated by reference herein.

### BACKGROUND

The present invention relates to a method of delivering a printed product to a binding or mailing line, and more particularly to a method of sequentially delivering printed products to a binding or mailing line.

Book as used herein refers to books, catalogs, magazines, pamphlets, envelopes and other printed materials. Books are typically assembled through either conventional saddle stitch or perfect binding processes and it should be noted that the present invention may be used in conjunction with saddle stitch, perfect binding, and other binding methods.

Publishers of printed media are continually looking to gain market share by maintaining and increasing the number of subscribers to its printed media. To help the publishers achieve their goals, printers provide publishers the capability of customizing printed media based on general demographic regions, the particular recipient, and the recipient's interests.

Books are generally comprised of one or more signatures. Signature as used herein generically refers to paper pages and/or packaging inserts. A signature may be printed by a printing press, a laser printer, an ink jet printer, a non-contact printer or any other type of printer. Printed products include both books and signature.

A book may be customized by including particular signatures within the book based on the location where the book will be sold. Books may be customized by including particular signatures within the book based on characteristics and interests of the recipient. Books may also be customized with the addition of inserts, inserts, electronic media, and the like.

A book may be further customized by including unique personalized information or indicia related to the recipient. A common way to personalize the book is to print the recipient's name and address information on the cover of the book once the book is assembled. The book may be further personalized by printing personalized indicia onto one or more signatures before or after the signatures are assembled into a book.

Signatures are often personalized while they are on the binding line by using an ink jet printer positioned near the binding line. As the signatures pass the ink jet printer, personalized information or indicia is printed onto one or more of the signatures or covers. Signatures may also be pre-personalized in a separate off-line printing process prior to being fed onto the binding line.

### SUMMARY

In one construction, the invention provides a method of delivering signatures to a finishing line. An assembly order is generated. The assembly order is provided to a controller that is operatively associated with a feeder that comprises a print-on-demand printer. The controller controls each of the following steps according to the assembly order: feeding blank paper to the print-on-demand printer of the feeder, printing a signature of the assembly order with the print-on-demand printer of the feeder, feeding the signature to a first pocket on the finishing line, feeding the signature from the first pocket to the finishing line, printing an additional signature of the assembly order with the print-on-demand printer, feeding the additional signature to the first pocket, and feeding the additional signature from the first pocket to the finishing line.

In another construction, the invention provides a signature delivery apparatus including a roll of blank paper, a feeder, a pocket, and a controller. The feeder includes a print-on-demand printer configured to receive blank paper from the roll. The pocket is associated with the feeder and configured to receive finished signatures that are printed by the print-on-demand printer and fed from the feeder. The controller is operatively associated with the feeder, the print-on-demand printer, and the pocket and configured to receive an assembly order. The controller is configured to control operation of the print-on-demand printer to print a signature and an additional signature of the assembly order from the blank paper, to control operation of the feeder to feed the signature and the additional signature to the pocket according to the assembly order, and to control operation of the pocket to feed the signature and the additional signature to the finishing line.

In yet another construction, the invention provides a signature delivery apparatus for a finishing line. The apparatus includes means for storing blank paper and means for generating finished signatures from the blank paper. The means for generating includes a means for printing on the blank paper to generate finished signatures. The apparatus further includes means for delivering the finished signatures that are printed by the means for printing to the finishing line, and means for controlling the means for generating, the means for printing, and the means for delivering. The means for controlling is configured to receive an assembly order and to control operation of the means for printing to print a signature and an additional signature from the blank paper, and to control operation of the means for generating to feed the signature and the additional signature to the means for delivering according to the assembly order, and to control operation of the means for delivering to feed the signature and the additional signature to the finishing line.

Other aspects of the invention will become apparent by consideration of the detailed description and accompanying drawings.

### BRIEF DESCRIPTION OF THE DRAWINGS

FIG. 1 is a plan view of a binding line for assembling a book.

FIG. 2 is an exemplary illustration of a roll of signatures including sequence codes.

FIG. 3 is a flow chart illustrating a method of delivering a signature to the binding line.

FIG. 4 is a flow chart illustrating a method of delivering a book to a mailing line.

FIG. 5 is a plan view of a binding line for assembling a book.

FIG. 6 is a plan view of a POD printer feeder.

FIG. 7 is a plan view of the POD printer feeder.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

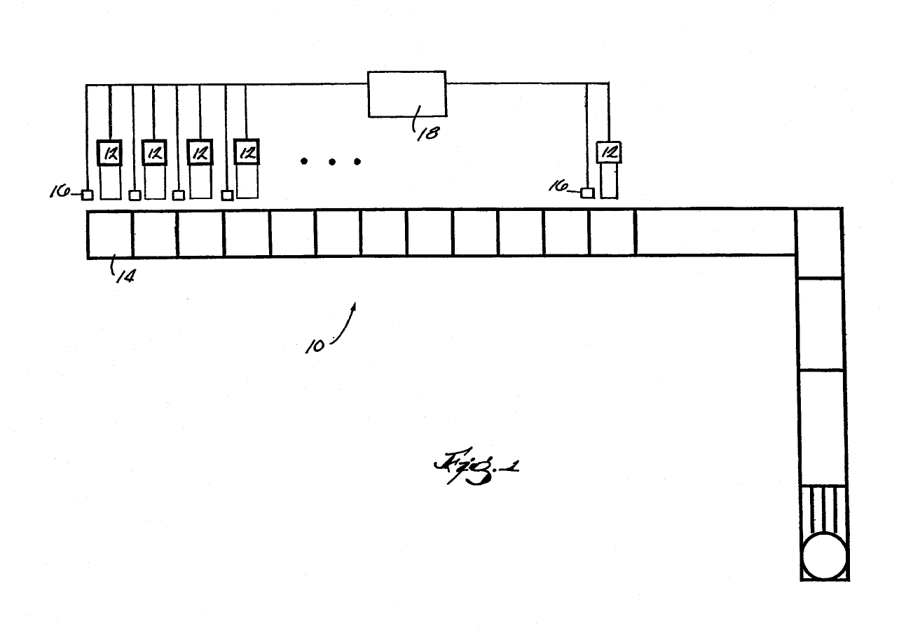

FIG. 1 illustrates a binding line 10 for assembling books. The binding line 10 includes a plurality of feeders 12 and a conveyor line 14. The feeders 12 contain signatures that will comprise a book. Although only five feeders 12 are shown delivering signatures to the conveyor line 14, it should be understood that binding line 10 may include additional or less feeders 12. In addition, any conventional feeder 12 can be used as part of the binding line 10 without departing from the scope of the present invention.

The binding line 10 includes a reader 16, i.e., bar code reader, scanner, etc., adjacent to each feeder 12. The readers 16 connect to a controller 18, as is known in the art, that processes the output from the readers 16. A suitable controller 18 is the FCS 2000 available from Quad/Tech, Inc. in Sussex, Wis. The controller 18 connects to the feeders 12 to control the delivery of the appropriate signature to the conveyor line 14.

The binding line 10 may include additional feeders, a print station, an inspection station, a stitcher, a trimming station, and a stacker downstream of the feeders 12 as are known in the art. The additional feeders positioned downstream of the feeders 12 may feed additional signatures and/or selective items, such as, order forms, postcards, special-interest publications, CD-ROMs, DVDs, subscription cards, promotional offers, coupons, etc. The print station can include an ink jet printer that prints personalized indicia, i.e., recipient name and address, on the cover or on an interior page of a book. The inspection station inspects each book for appropriate thickness or print quality by a caliper or other sensor. This information is transmitted to the controller 18, which compares the measured thickness or print quality with a reference thickness or print quality in order to determine if the book has been appropriately assembled. If an error was made in the assembly of the book, the book is rejected from the binding line 10.

The stitcher binds, i.e., stapled, glued, stitched, and fastened, each book, and the trimming station trims the edges of each book. The stacker bundles together books that are being delivered to a common zip code, or other predetermined order, for easy handling by the U.S. Postal Service. Other stations or operations may be included in the binding line 10 that are known in the art.

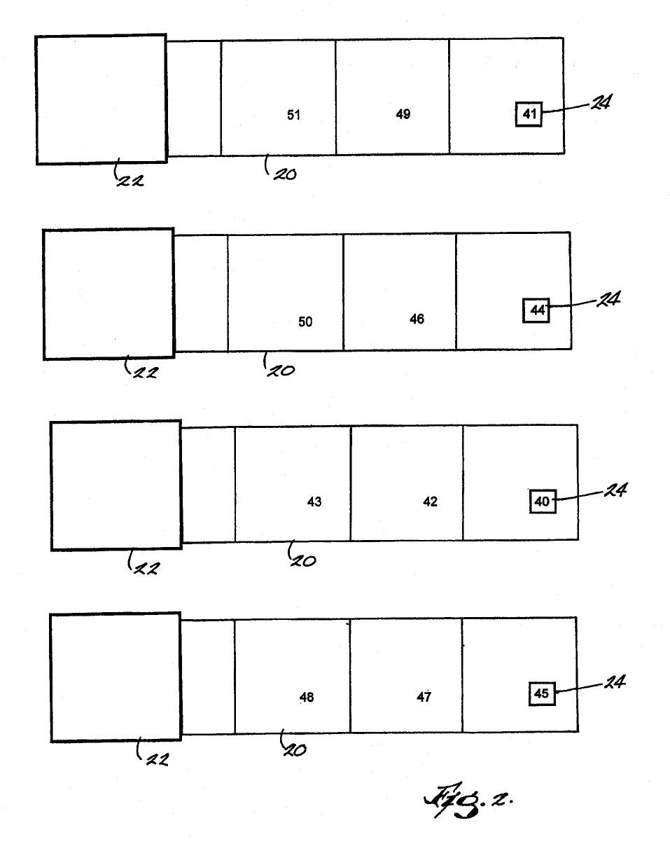

FIG. 2 illustrates stored signatures such as on the four rolls 22. The pre-printed signatures 20 may also be wound onto a roll 22 in a fan fold method. Further, other storage methods may also be utilized in addition to rolls such as containers, piles, and the like, that keep a sequence. Each signature 20 on a roll may have the same content or different content depending on the publication. The content may include advertising, special promotional offers, or subscriber indicia, and the content may vary depending on the subscriber's demographics and interests. Each signature 20 includes thereon a sequence code 24. The sequence code 24 may be a U.S. Postal Service zip code, a bar code, a reference number, a sequence number or any identifying code. The sequence code 24 may be printed with invisible ink.

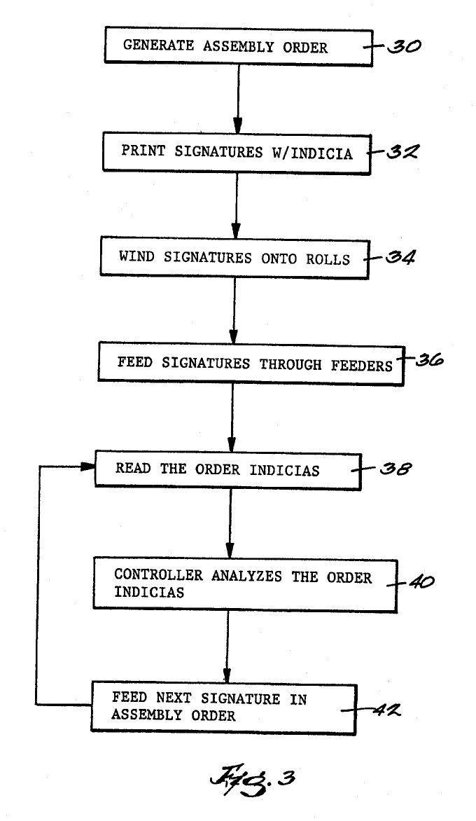

One embodiment of the method of the invention is illustrated in the flow chart in FIG. 3. Prior to printing the signatures 20, an assembly order is generated at step 30. The assembly order may be an order to build the books being delivered to a common zip code, or other predetermined order, for easy handling by the U.S. Postal Service or any other delivery service. Based on the assembly order, signatures are printed that each include the sequence code 24 at step 32. At step 34, the printed signatures 20 are wound onto one of several rolls 22 according to the assembly order.

Each wound roll 22 is positioned adjacent to a feeder 12 and each signature 20 is separated from the role and fed through the corresponding feeder 12 toward the reader 16 at step 36. At step 38, the reader 16 reads the sequence code 24 on each signature that is nearest the conveyor line 14, that is, next-in-line. At step 40, the controller 18 analyzes the outputs from each of the readers 16 to determine which signature of those that are next-in-line for each roll 22 is next in the assembly order. The controller 18 sends a signal to a respective feeder 12 to feed the next signature in the assembly order at step 42. Once a signature is fed to the conveyor line 14, the next signature on the roll takes its place as being next-in-line. The process continues at step 38. The reader 16 reads the sequence code 24 on each signature that is next-in-line for each roll 22. The controller 18 analyzes the reader 16 output and transmits a signal to the feeder 12 to feed the next signature in the assembly order. It should also be noted that a signature could be separated from its respective roll 22 after the sequence code 24 thereon has been read by the reader 16.

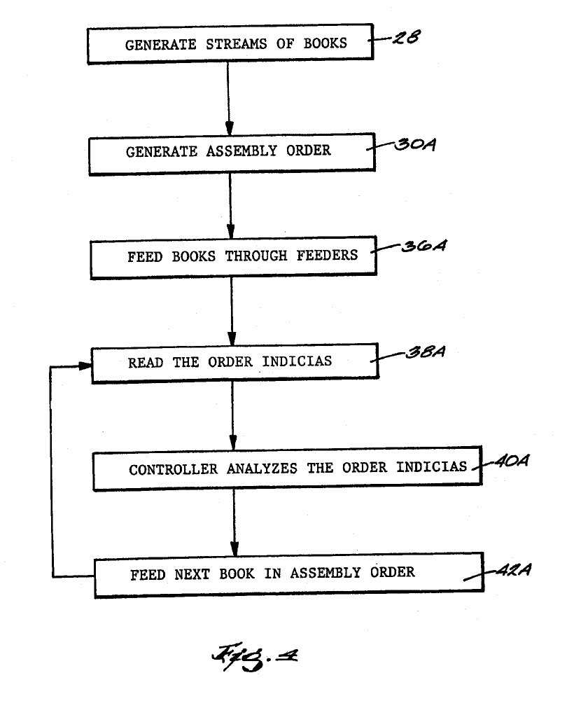

Another embodiment of the invention is illustrated in the flow chart in FIG. 4. Common steps are identified by the same reference number with an appended “A”. Several streams of books including order indicia 24 are generated in an off-line process at step 28. The streams of books may be the same publication or various types of publications, mail, or other printed pieces. Each stream of books may also be of a differing class of mail, e.g., first class, second class, or third class, from another stream of books. Each stream of books may also include mixed classes of printed pieces. The combination of streams of books reduces costs to mailers and reduces the handling costs to the U.S. Postal Service.

Next, an assembly order is generated at step 30A by analyzing the various files that generated each stream of books. Each stream of books is fed to a feeder 12. Each book is fed through the corresponding feeder 12 toward the reader 16 at step 36A. The reader 16 reads, at step 38A, the sequence code 24 on each book that is nearest the conveyor line 14. At step 40A, the controller 18 analyzes the outputs from each of the readers 16 to determine which book is next in the assembly order. The controller 18 sends a signal to the feeder 12 to feed the next book in the assembly order at step 42A to the mailing line. The process continues at step 38A. The reader 16 reads the order indicia 24 on each book that is nearest the conveyor 14. The controller 18 analyzes the reader 16 output and transmits a signal to the feeder 12 to feed the next book in the assembly order.

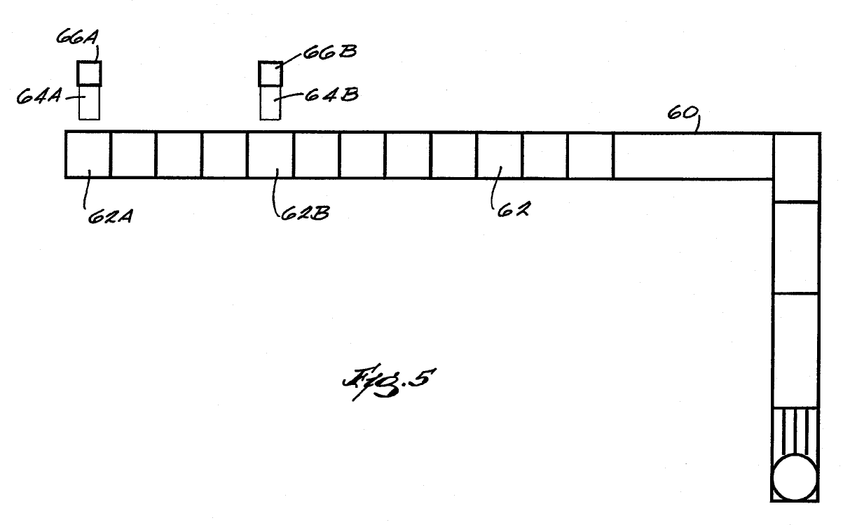

Turning now to FIGS. 5-7, another embodiment of the invention is shown. In this embodiment, print-on-demand (POD) technology is utilized as a way to have multiple printed product streams gathered together using one pocket and as a result actually creating one stream. POD technology enables the use of one pocket to combine individual streams of printed products. POD technology can be used in conjunction with traditional feeders and pockets if different sized signatures, varying folding techniques, increased speed, back-up efficiencies, additional color requirements, for example, are desired. In other cases, one POD component may be sufficient.

As shown in FIG. 5, a binding line 60 includes multiple pockets 62. Pockets 62A and 62B have associated therewith a POD feeder 64A and 64B, respectively, each have thereon a POD printer 66A and 66B, respectively.

Multiple POD technology components can be used on the binding line 60 as shown in FIG. 5. As an example, the first POD feeder 64A prints and feeds the driver piece using a bar code as described above and the second POD feeder 64B prints and feeds in sequence to match the driver piece. Scanners, cameras or similar technology could be used to verify that the match of these signatures have in fact been established.

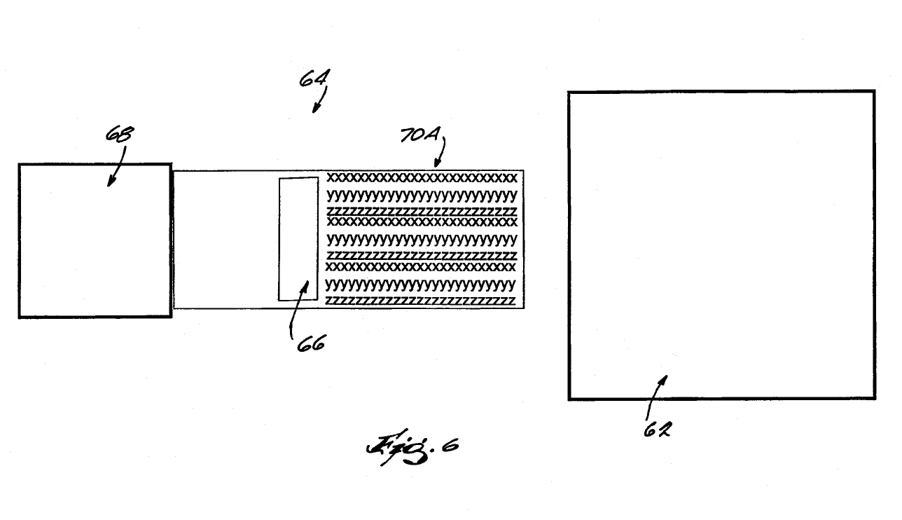

Referring now to FIGS. 6 and 7, POD technology enables all the information required on the printed products, such as a signature, to be printed at the same time. Borders, varying colors, common text and/or variable text, for example, can all be printed on demand in real time, therefore, individual streams of printed products can be printed as one mail stream and with the use of one pocket. Examples of POD technology include the VersaMark Printing System available from Scitex and the DocuTech Production Printer available from Xerox. A blank roll of paper 68 is fed to the POD printer 66 which prints each individual printed product, such as signatures 70A, 70B and 70C. The printed products 70 are then fed to the pocket 62.

It should be noted that with all embodiments, books do not need to be assembled in the exact assembly order to ensure that the books are being manufactured correctly. Due to the sequence code and/or POD technology being utilized, a book can be assembled correctly as controlled by the controller, based on the code alone, regardless of sequence order. If mailing requirements change, the precise sequence the books are manufactured in becomes less important.

The present invention is not limited to the forms shown and described above. Alternate forms will be apparent to those skilled in the art and are within the intended scope of the present invention. The forms described herein are further intended to explain the best modes known for practicing the invention and to enable those skilled in the art to utilize the invention in such, or other, forms and with various modifications required by the particular applications or uses of the present invention. It is intended that the appended claims be construed to include alternative forms to the extent permitted by the prior art.

What is claimed is:

1. A method of delivering signatures to a finishing line comprising:
generating an assembly order;
providing the assembly order to a controller that is operatively associated with a feeder that comprises a print-on-demand printer;
feeding blank paper to the print-on-demand printer of the feeder; and
controlling with the controller each of the following steps according to the assembly order:
printing a signature of the assembly order with the print-on-demand printer of the feeder;
feeding the signature to a first pocket on the finishing line;
feeding the signature from the first pocket to the finishing line;
printing an additional signature of the assembly order with the print-on-demand printer;
feeding the additional signature to the first pocket; and
feeding the additional signature from the first pocket to the finishing line.

2. The method of claim 1, wherein the signature and the additional signature are part of a first book, the method further comprising grouping the signature and the additional signature together on the finishing line.

3. The method of claim 2, wherein the signature and the additional signature are fed from the first pocket and stacked on the finishing line.

4. The method of claim 2, wherein, according to the assembly order, the first book includes a supplementary signature, the method further comprising feeding the supplementary signature of the assembly order from a supplementary feeder on the finishing line, grouping the supplementary signature with the signature and the additional signature on the finishing line, and assembling the first book.

5. The method of claim 4, wherein the supplementary signature is pre-printed, the method further comprising loading the pre-printed supplementary signature into the supplementary feeder.

6. The method of claim 1, wherein the signature and the additional signature are printed to have completely different content.

7. The method of claim 1, wherein, according to the assembly order, the signature is part of a first book and the additional signature is part of a second book, the method further comprising feeding a supplementary signature of the first book from a first supplementary feeder on the finishing line, and feeding a supplementary signature of the second book from a second supplementary feeder on the finishing line.

8. The method of claim 7, further comprising grouping the signature with the supplementary signature of the first book on the finishing line and assembling the first book, and grouping the additional signature with the supplementary signature of the second book on the finishing line and assembling the second book.

9. The method of claim 7, wherein the supplementary signatures of the first and second books are pre-printed, the method further comprising loading the pre-printed supplementary signatures of the first and second books into the first and second supplementary feeders, respectively.

10. A printed product assembly system for a finishing line, the system comprising:
a roll of blank paper;
a feeder comprising a print-on-demand printer configured to receive blank paper from the roll;
a pocket associated with the feeder and configured to receive finished signatures that are printed by the print-on-demand printer and fed from the feeder; and
a controller that is operatively associated with the feeder, the print-on-demand printer, and the pocket and configured to receive an assembly order and to control operation of the print-on-demand printer to print a signature and an additional signature of the assembly order from the blank paper, to control operation of the feeder to feed the signature and the additional signature to the pocket according to the assembly order, and to control operation of the pocket to feed the signature and the additional signature to the finishing line.

11. The system of claim 10, further comprising a stitcher positioned downstream of the pocket, the stitcher being configured to stitch the signature and the additional signature into a book.

12. The system of claim 11, further comprising an additional feeder configured to receive a plurality of printed signatures and to feed one of the plurality of printed signatures to the stitcher for stitching into the book.

13. The system of claim 10, further comprising:
a stitcher positioned downstream of the pocket;
a first supplementary feeder configured to receive a first supplementary pre-printed signature and feed the first supplementary pre-printed signature to the stitcher for stitching into a first book with the signature printed by the print-on-demand printer; and
a second supplementary feeder configured to receive a second supplementary pre-printed signature and feed the second supplementary pre-printed signature to the stitcher for stitching into a second book with the additional signature printed by the print-on-demand printer.

14. A signature delivery system for a finishing line, the signature delivery system comprising:
means for storing blank paper;
means for generating finished signatures from the blank paper, wherein the means for generating comprises a means for printing on the blank paper to generate finished signatures;
means for delivering the finished signatures that are printed by the means for printing to the finishing line; and
means for controlling the means for generating, the means for printing, and the means for delivering and configured to receive an assembly order and to control operation of the means for printing to print a signature and an additional signature from the blank paper and to control operation of the means for generating to feed the signature and the additional signature to the means for delivering according to the assembly order, and to control operation of the means for delivering to feed the signature and the additional signature to the finishing line.

15. The system of claim 14, further comprising means for grouping the signature and the additional signature together, and means for assembling a first book to include the signature and the additional signature.

16. The system of claim 15, further comprising means for feeding a supplementary signature of the assembly order, means for grouping the supplementary signature with the signature and the additional signature generated by the means for printing, and means for assembling the first book to include the supplementary signature as well as the signature and the additional signature generated by the means for printing.

17. The system of claim 16, further comprising means for pre-printing the supplementary signature, and means for loading the pre-printed supplementary signature into the supplementary feeding means.

18. The system of claim 14, wherein, according to the assembly order, the signature is part of a first book and of the additional signatures is part of a second book, the finishing line further comprising means for feeding a supplementary signature of the first book, and means for feeding a supplementary signature of the second book.

19. The system of claim 18, further comprising means for grouping the signature with the supplementary signature of the first book, means for assembling the first book, means for grouping the additional signature with the supplementary signature of the second book, and means for assembling the second book.

20. The system of claim 18, further comprising means for pre-printing the supplementary signatures of the first and second books, and means for loading the pre-printed supplementary signatures into the respective means for feeding the supplementary signatures.

21. A method of delivering signatures to a finishing line comprising:
generating an assembly order;
providing the assembly order to a controller that is operatively associated with a feeder that comprises a print-on-demand printer;
providing paper to the print-on-demand printer of the feeder; and
controlling with the controller each of the following steps according to the assembly order: printing on a signature of the assembly order with the print-on-demand printer of the feeder, feeding the signature to a first pocket on the finishing line, delivering the signature from the first pocket to the finishing line, printing on an additional signature of the assembly order with the print-on-demand printer, feeding the additional signature to the first pocket, and delivering the additional signature from the first pocket to the finishing line.

22. The method of claim 21, wherein providing paper to the print-on-demand printer of the feeder comprises providing blank paper to the print-on-demand printer of the feeder.

23. The method of claim 21, wherein printing on the signature comprises printing first content on the signature and printing on the additional signature comprises printing content different from the first content on the additional signature.

24. The method of claim 21, wherein printing on each of the signature and the additional signature with the print-on-demand printer of the feeder includes printing at least one of: borders, varying colors, common text, and varying text.
